(19) United States
(12) Patent Application Publication
(10) Pub. No.: US 2016/0141632 A1
(43) Pub. Date: May 19, 2016

(54) CATALYST PROPERTY CONTROL WITH INTERMIXED INORGANICS

(71) Applicant: 3M INNOVATIVE PROPERTIES COMPANY, St. Paul, MN (US)

(72) Inventors: Mark K. Debe, Stillwater, MN (US); Radoslav Atanasoski, Oakland, CA (US); Susan M. Hendricks, Lake Elmo, MN (US); Jeffrey R. Dahn, Upper Tantallon (CA); David A. Stevens, Hubley (CA); Arnd Garsuch, Ludwigshafen am Rhein (DE); Robert J. Sanderson, Halifax (CA)

(21) Appl. No.: 15/004,568

(22) Filed: Jan. 22, 2016

Related U.S. Application Data
(62) Division of application No. 14/252,343, filed on Apr. 14, 2014.
Application No. 14/252,343 is a division of application No. 12/766,359, filed on Apr. 23, 2010, now abandoned.
(60) Provisional application No. 61/172,118, filed on Apr. 23, 2009.

(51) Int. Cl. H01M 4/92

(52) U.S. Cl. CPC H01M 4/921

(57) ABSTRACT

Nanostructured thin film catalysts which may be useful as fuel cell catalysts are provided, the catalyst materials including intermixed inorganic materials. In some embodiments the nanostructured thin film catalysts may include catalyst materials according to the formula PtₓM₍₁₋ₓ₎ where x is between 0.3 and 0.9 and M is Nb, Bi, Re, Hf, Cu or Zr. The nanostructured thin film catalysts may include catalyst materials according to the formula PtₐCo_{b}M_{c} where a+b+c=1, a is between 0.3 and 0.9, b is greater than 0.05, c is greater than 0.05, and M is Au, Zr, or Ir. The nanostructured thin film catalysts may include catalyst materials according to the formula PtₐTi_{b}Q_{c} where a+b+c=1, a is between 0.3 and 0.9, b is greater than 0.05, c is greater than 0.05, and Q is C or B.

### CROSS REFERENCE TO RELATED APPLICATIONS

This application is a divisional application of pending prior U.S. application Ser. No. 14/252,343, filed Apr. 14, 2014, which claims the benefit of U.S. application Ser. No. 12/766,359, filed Apr. 23, 2010, abandoned, which claims the benefit of U.S. Provisional Patent Application No. 61/172118, filed Apr. 23, 2009, the disclosures of which are incorporated by reference herein in their entireties.

This invention was made with Government support under Cooperative Agreement DE-FG36-07GO17007 awarded by DOE. The Government has certain rights in this invention.

### FIELD OF THE DISCLOSURE

This disclosure relates to nanostructured thin film (NSTF) catalysts comprising intermixed inorganic materials, which may be useful as fuel cell catalysts.

### BACKGROUND OF THE DISCLOSURE

U.S. Pat. No. 5,879,827, the disclosure of which is incorporated herein by reference, discloses nanostructured elements comprising acicular microstructured support whiskers bearing acicular nanoscopic catalyst particles. The catalyst particles may comprise alternating layers of different catalyst materials which may differ in composition, in degree of alloying or in degree of crystallinity.

U.S. Pat. No. 6,482,763, the disclosure of which is incorporated herein by reference, discloses fuel cell electrode catalysts comprising alternating platinum-containing layers and layers containing suboxides of a second metal that display an early onset of CO oxidation.

U.S. Pat. Nos. 5,338,430, 5,879,828, 6,040,077 and 6,319,293, the disclosures of which are incorporated herein by reference, also concern nanostructured thin film catalysts.

U.S. Pat. Nos. 4,812,352, 5,039,561, 5,176,786, and 5,336,558, the disclosures of which are incorporated herein by reference, concern microstructures.

U.S. Pat. No. 7,419,741, the disclosure of which is incorporated herein by reference, discloses fuel cell cathode catalysts comprising nanostructures formed by depositing alternating layers of platinum and a second layer onto a microstructure support, which may form a ternary catalyst.

U.S. Pat. No. 7,622,217, the disclosure of which is incorporated herein by reference, discloses fuel cell cathode catalysts comprising microstructured support whiskers bearing nanoscopic catalyst particles comprising platinum and manganese and at least one other metal at specified volume ratios and Mn content, where other metal is typically Ni or Co.

### SUMMARY OF THE DISCLOSURE

Briefly, the present disclosure provides a fuel cell catalyst comprising microstructured support whiskers bearing a thin film of nanoscopic catalyst particles comprising a catalyst material according to the formula PtₓM₍₁₋ₓ₎ where x is between 0.3 and 0.9 and M is selected from the group consisting of Nb, Bi, Re, Hf, Cu and Zr. In some embodiments, M is Nb. In some embodiments, M is Nb and x is between 0.6 and 0.9. In some embodiments, M is Nb and x is between 0.7 and 0.8. In some embodiments, M is Bi. In some embodiments, M is Bi and x is between 0.6 and 0.9. In some embodiments, M is Bi and x is between 0.65 and 0.75. In some embodiments, M is Re. In some embodiments, M is Re and x is between 0.52 and 0.90. In some embodiments, M is Re and x is between 0.52 and 0.69. In some embodiments, M is Cu. In some embodiments, M is Cu and x is between 0.30 and 0.8. In some embodiments, M is Cu and x is between 0.32 and 0.42. In some embodiments, M is Hf. In some embodiments, M is Hf and x is between 0.65 and 0.93. In some embodiments, M is Hf and x is between 0.72 and 0.82. In some embodiments, M is Zr. In some embodiments, M is Zr and x is between 0.60 and 0.9. In some embodiments, M is Zr and x is between 0.66 and 0.8.

In another aspect, the present disclosure provides a fuel cell catalyst comprising nanostructured elements comprising microstructured support whiskers bearing a thin film of nanoscopic catalyst particles comprising a catalyst material according to the formula Ptₓ(LiF)₍₁₋ₓ₎ where x is between 0.3 and 0.9. In some embodiments, x is between 0.5 and 0.8.

In another aspect, the present disclosure provides a fuel cell catalyst comprising nanostructured elements comprising microstructured support whiskers bearing a thin film of nanoscopic catalyst particles comprising a catalyst material according to the formula PtₐCo_{b}M_{c} where a+b+c=1, a is between 0.3 and 0.9, b is greater than 0.05, c is greater than 0.05, and M is selected from the group consisting of Au, Zr, and Ir. In some embodiments, M is Au. In some embodiments the catalyst material is according to the formula PtₓCo_{(x/2.2)}Au_{(1-x-x/2.2)} where x is between 0.53 and 0.58. In some embodiments, M is Zr. In some embodiments the catalyst material is according to the formula Pt_{(1-x-y)}CoₓZr_{y} where x and y satisfy the conditions 2y+x>0.35, 4y+x>1.00 and x<0.7. In some embodiments, M is Ir. In some embodiments, the catalyst material is according to the formula PtₓCo_{(x/3.9)}Ir_{(1-x-x/3.9)} where x is between 0.63 and 0.76, and more typically x is between 0.65 and 0.69.

In another aspect, the present disclosure provides a fuel cell catalyst comprising nanostructured elements comprising microstructured support whiskers bearing a thin film of nanoscopic catalyst particles comprising a catalyst material according to the formula PtₐTi_{b}Q_{c} where a+b+c=1, a is between 0.3 and 0.9, b is greater than 0.05, c is greater than 0.05, and Q is selected from the group consisting of C and B. In some embodiments Q is C. In some embodiments the catalyst material is according to the formula Pt_{0.5}(TiₓC₍₁₋ₓ₎)_{0.5} where x is between 0.3 and 0.82, and more typically x is between 0.4 and 0.7. In some embodiments the catalyst material is according to the formula Ptₓ(TiC)_{((1-x)/2)} where x is between 0.4 and 0.7. In some embodiments Q is B. In some embodiments the catalyst material is according to the formula Pt_{0.5}(TiₓB₍₁₋ₓ₎)_{0.5} where x is between 0.10 and 0.88, and more typically x is between 0.52 and 0.82.

In another aspect, the present disclosure provides a fuel cell catalyst comprising nanostructured elements comprising microstructured support whiskers bearing a thin film of nanoscopic catalyst particles comprising a catalyst material according to the formula Ptₓ(SiO₂)₍₁₋ₓ₎ where x is between 0.7 and 1

In another aspect, the present disclosure provides a fuel cell catalyst comprising nanostructured elements comprising microstructured support whiskers bearing a thin film of nanoscopic catalyst particles comprising a catalyst material according to the formula Ptₓ(ZrO₂)₍₁₋ₓ₎ where x is between 0.65 and 0.8.

In another aspect, the present disclosure provides a fuel cell catalyst comprising nanostructured elements comprising microstructured support whiskers bearing a thin film of nanoscopic catalyst particles comprising a catalyst material according to the formula Ptₓ(Al₂O₃)_{(2(1-x)/5)} where x is between 0.3 and 0.7.

In another aspect, the present disclosure provides a fuel cell catalyst comprising nanostructured elements comprising microstructured support whiskers bearing a thin film of nanoscopic catalyst particles comprising a catalyst material according to the formula Ptₓ(TiSi₂)_{((1-x)/3)} where x is between 0.8 and 0.95.

In another aspect, the present disclosure provides a fuel cell catalyst comprising nanostructured elements comprising microstructured support whiskers bearing a thin film of nanoscopic catalyst particles comprising a catalyst material according to the formula Ptₓ(TiO₂)_{((1-x)/3)} where x is between 0.3 and 0.7.

In another aspect, the present disclosure provides a fuel cell catalyst comprising nanostructured elements comprising microstructured support whiskers bearing a thin film of nanoscopic catalyst particles comprising a catalyst material according to the formula Ptₓ(Misch Metal)₍₁₋ₓ₎ where x is between 0.4 and 0.85.

In another aspect, the present disclosure provides a fuel cell catalyst comprising nanostructured elements comprising microstructured support whiskers bearing a thin film of nanoscopic catalyst particles comprising a catalyst material according to the formula Ptₓ(Co_{0.9}Mn_{0.1})_{(x/1.7)}(SiO₂)_{((1-x-x/1.7)/3)} where x is between 0.3 and 0.6.

In this application:

“membrane electrode assembly” means a structure comprising a membrane that includes an electrolyte, typically a polymer electrolyte, and at least one but more typically two or more electrodes adjoining the membrane;

“nanostructured element” means an acicular, discrete, microscopic structure comprising a catalytic material on at least a portion of its surface;

“nanoscopic catalyst particle” means a particle of catalyst material having at least one dimension equal to or smaller than about 15 nm or having a crystallite size of about 15 nm or less, as measured from diffraction peak half widths of standard 2-theta x-ray diffraction scans;

“thin film of nanoscopic catalyst particles” includes films of discrete nanoscopic catalyst particles, films of fused nanoscopic catalyst particles, and films of nanoscopic catalyst grains which are crystalline or amorphous; typically films of discrete or fused nanoscopic catalyst particles, and most typically films of discrete nanoscopic catalyst particles;

“acicular” means having a ratio of length to average cross-sectional width of greater than or equal to 3;

“discrete” refers to distinct elements, having a separate identity, but does not preclude elements from being in contact with one another;

“microscopic” means having at least one dimension equal to or smaller than about a micrometer;

“planar equivalent thickness” means, in regard to a layer distributed on a surface, which may be distributed unevenly, and which surface may be an uneven surface (such as a layer of snow distributed across a landscape, or a layer of atoms distributed in a process of vacuum deposition), a thickness calculated on the assumption that the total mass of the layer was spread evenly over a plane covering the same area as the projected area of the surface (noting that the projected area covered by the surface is less than or equal to the total surface area of the surface, once uneven features and convolutions are ignored);

“bilayer planar equivalent thickness” means the total planar equivalent thickness of a first layer (as described herein) and the next occurring second layer (as described herein).

It is an advantage of the present disclosure to provide catalysts for use in fuel cells.

### BRIEF DESCRIPTION OF THE DRAWINGS

FIGS. 1-20 are graphs representing Pt[111] grain size, Pt[111] lattice constant, and surface area ratios (SEF) for various embodiments of the present specification, as described in the Examples below.

### DETAILED DESCRIPTION

This disclosure relates to fuel cell catalysts containing platinum (Pt) which can be characterized as having a grain size, a Pt fcc lattice spacing, and surface area of Pt in the catalyst particles. This disclosure relates to materials used in methods of manipulating grain size, a Pt fcc lattice spacing, and surface area independent of catalyst loading and the resulting catalyst materials.

The size of the catalyst particle is important because it can directly determine the available mass specific surface area (m²/g) of the catalyst and how well the catalyst mass is utilized by its surface reactions. The Pt fcc lattice spacing in an alloy is important because it directly reflects changes in the electronic band structure of the alloy and ultimately the Pt—Pt spacing on the surface that determine how strongly O₂ and OH⁻ adsorb onto the catalyst surface and thereby the resultant kinetic rate for the oxygen reduction reaction. Specifically this disclosure relates to materials used in methods for controlling the catalyst particle or grain size, and lattice parameter, determined from X-ray diffraction, by intermixing layers of the catalyst, such as Pt, with various inorganic material layers. This disclosure relates to materials used in methods to obtain a desired grain size, lattice parameter and increased catalyst surface area, independent of catalyst loading, for different atomic ratios of the catalyst/intermixed material. The preferred method for depositing the layers is by vacuum deposition methods, and the preferred catalyst supports are high aspect ratio (>3) structures. This disclosure is particularly relevant to the nanostructured thin film (NSTF) supported catalysts.

NSTF catalysts are highly differentiated from conventional carbon supported dispersed catalysts in multiple ways. The four key differentiating aspects are: 1) the catalyst support is an organic crystalline whisker that eliminates all aspects of the carbon corrosion plaguing conventional catalysts, while facilitating the oriented growth of Pt nanowhiskers (whiskerettes) on the whisker supports; 2) the catalyst coating is a nanostructured thin film rather than an isolated nanoparticle that endows the NSTF catalysts with a ten-fold higher specific activity for oxygen reduction (ORR), the performance limiting fuel cell cathode reaction; 3) the nanostructured thin film morphology of the catalyst coating on the NSTF whisker supports endows the NSTF catalyst with more resistance to Pt corrosion under high voltage excursions while producing much lower levels of per-oxides that lead to premature membrane failure; and 4) the process for forming the NSTF catalysts and support whiskers is an all dry roll-good process that makes and disperses the support whiskers as a monolayer and coats them with catalyst on a moving web, all potentially in a single pass. The disclosures of following patents are incorporated herein by reference: U.S. Pat. No. 7,419,741; U.S. Pat. No. 5,879,827; U.S. Pat. No. 6,040,077; U.S. Pat. No. 5,336,558; U.S. Pat. No. 5,336,558; U.S. Pat. No. 5,336,558; U.S. Pat. No. 6,136,412.

The NSTF catalyst is particularly useful for meeting PEM fuel cell performance and durability requirements with very low loadings of precious metal catalysts. The key issue with any catalyst for any application is to utilize the catalyst mass as effectively as possible. This means increasing the mass specific area (m²/g) so that the ratio of surface area to mass is as high as possible, but without losing specific activity for the key ORR reaction. Absolute activity of a fuel cell electrocatalyst is the product of both the surface area and the specific activity, and for conventional dispersed catalysts specific activity decreases significantly when the mass specific surface area is increased by reducing the particle size. In addition, smaller catalyst particles tend to be more unstable with respect to Pt corrosion and dissolution mechanisms. So there is generally an optimum desired size for conventional dispersed catalysts in the several nanometer range which compromises the gain in surface area with loss of specific activity and durability.

The grain sizes of the nanostructured catalyst film coating formed on the NSTF crystalline organic whiskers are typically larger than conventional dispersed Pt/Carbon catalysts, resulting in lower total surface area and mass specific area (m²/g). Reducing the grain size for any given loading is desirable in order to determine the best value that gives optimum surface area while maintaining the fundamentally higher specific activity and stability. It is also desirable to be able to control the grain size independent of either the precious metal catalyst loading or atomic fraction of the active catalyst component, such as Pt, relative to any other intermixed elements or compounds used to make the overall catalyst. In this disclosure we disclose the use of various inorganic elements and compounds as interlayered materials with Pt, to produce intermixed catalysts with widely varying and controllable grain sizes and surface areas.

Heretofore the grain size of the vacuum deposited (using electron beam evaporation or magnetron sputter deposition) coatings on the NSTF whiskers were controlled by the total catalyst loading on the whisker supports (expressed for example in mg of Pt per cm² of electrode active area) and the surface area of those support whiskers (generally the areal number density and lengths). With this disclosure, we teach how the grain size can be obtained independent of the loading or whisker support. We further illustrate how the catalyst surface area as measured by electrochemical hydrogen adsorption-desorption, can also be controlled by the crystallite grain size through this disclosure.

This disclosure concerns an approach to increasing both the NSTF surface area and specific activity at reduced loadings (<0.25 mg-Pt/cm² total). It is an unexpected result of the current disclosure that the function of one conformal coating material is to directly affect and control the physical properties (e.g. Pt grain sizes and shapes) of the adjacent conformal coating material during deposition of the conformal coatings.

### EXAMPLES

The ability to obtain arbitrary grain sizes and surface areas are illustrated with catalysts made with alternating ultra-thin layers of Pt and additional materials, as noted:
A. Pt binaries: PtNb, PtBi, PtRe, PtCu, PtHf, PtZr and Pt(LiF)
B. Pt ternaries: PtCoAu, PtCoZr, PtCoIr, PtTiC and PtTiB
C. Pt compounds: Pt(SiO₂), Pt(ZrO₂), Pt(Al₂O₃), Pt(TiSi₂), Pt(TiO₂), Pt(Misch Metal) and Pt(CoMn)(SiO₂)

Misch Metal is an alloy of rare earth elements, in these examples consisting of Ce (51%), La (28.6%), Nd (12.3%), Pr (4.6%), and the remainder Fe and Mg.

In the case of the Pt binaries, each of the two elements were deposited from a separate sputtering source. In the case of the Pt ternaries, each of the three elements were deposited from separate sputtering sources. In the case of the Pt compounds and Pt(LiF), Pt and materials in parentheses were deposited from separate sputtering sources.

For all the samples/examples, the catalysts were deposited onto the NSTF whisker supports fabricated as a roll-good on the MCTS (microstructured catalyst transfer substrate) described in various patents cited above. The bare whisker coated MCTS substrates were cut into square sections roughly 4 inches on a side for coating with the alternating catalysts as described below.

The alternating layers of Pt and ad-material were deposited onto the NSTF support whiskers by vacuum sputter deposition. The ad-materials consisted of single elements for making intermixed Pt-binary catalyst, dual elements for making intermixed Pt-ternary catalyst, and inorganic compounds for making intermixed Pt-compound catalysts. For each material composition, samples were fabricated into arrays of 64 individual disc-shaped areas, each about 4 mm in diameter. The 8×8 arrays covered roughly a 50 cm² (4″×4″) planar area covered with a uniform coating of the NSTF support whiskers. During deposition of the catalyst onto the whisker support film, the sample array was passed repeatedly and successively over the different material target stations, with specialized masks intervening at each station to control the rate of deposition versus x-y position on the substrate. The masks and their orientation were controlled to achieve the desired gradient in material depositions onto the different array elements, as described in J. R. Dahn et al., Chem. Mater. 2002, 14, 3519-3523, the disclosure of which is incorporated herein by reference. For example, a typical distribution of material compositions over the 64 sample array for a Pt ternary might have a constant Pt loading of 0.15 mg/cm² at each array disc (obtained with a “constant mask”), a uniformly increasing loading of element M₁ for rows 1 to 8 of the array (obtained with a “linear-in” mask), and a uniformly increasing loading of element M₂ for columns 8 to 1 (obtained with a “linear-out” mask), of the array. In this way intermixed catalyst compositional array sets could be made with varying and controlled composition using just two sputtering targets for the Pt binary and Pt-compound catalysts, or three targets for the Pt ternary catalysts. Multiple such sample sheets were prepared during any given deposition run, to be used for different purposes. Some would be made into membrane electrode assemblies for fuel cell testing as described below, some would be used directly for characterization of mass loadings by electron micro-probe analysis, determination of grain sizes and lattice spacings by X-ray diffraction, and some would be used for chemical stability under accelerated acid soak tests.

It is important to note that the planar equivalent layer thickness deposited with each pass over any given target was very small, consisting of generally less than or on the order of a monolayer of material. For example, the sample table rotated at 14 rpm. To deposit 0.15 mg/cm² of Pt or 750 Angstroms, at the target power conditions used required 42 minutes. The number of table rotations then was 588 resulting in a planar equivalent Pt layer thickness per pass of just 1.276 Angstroms. This planar equivalent thickness is distributed over the actual surface area of the NSTF whisker support film, which has an effective roughness factor on the order of five to ten. This would make the effective layer thickness of any given material deposited onto the sides of the support whiskers much less than a monolayer. Typically, hundreds of layers were used to fabricate each array sample.

For the non-oxide compounds and metallic elements, DC magnetron sputtering was used, typically at ˜0.8 mTorr of Ar. The target power and voltage were controlled to obtain the desired deposition rate. For example, for the Pt—Hf case, the Pt target power and voltage were 48 watts and 402 volts, and for Hf it was 99 watts and 341 volts. For some of the insulating target materials, such as SiO₂, radio-frequency plasma sputter deposition with a DC bias was used.

After the catalysts were deposited onto the 64-element arrays, catalyzed electrode array discs were transferred to one side of a proton exchange membrane to function as the cathode of a membrane electrode assembly (MEA). For the MEA anode side, a continuous layer of NSTF whiskers coated with 0.2 mg/cm² of pure Pt (fabricated as a roll-good) was used. The catalyst transfer to the membrane to form the

MEA was done by hot roll lamination as described in various patents cited above. A 4″ square sheet of the anode electrode material, and the 4″ square sheet of the cathode array elements, were placed on either side of the membrane (generally a 830 EW ionomer, 35 micron thick). This was followed by placing various sheets of polyimide film and printing paper on the outsides of the assembly of sample/membrane sheets to form a sandwich assembly. The function of the printing paper was to improve the uniformity of nip pressure regardless of imperfections in the steel rolls of the laminator.

The assembly was then passed through the nip of a laminator with 3″ diameter heated rolls (350° F.) at 1 ft per minute and approximately 1000 pounds of force applied to each end of the laminator roller. After passing through the nip, the various sheets of the sandwich were removed, the MCTS backing films were peeled away from the membrane, leaving the catalyst coated whiskers imbedded on each side of the membrane. The MEA so formed was then installed into a 64 channel segmented cell for evaluation of electrochemical surface area, fuel cell oxygen reduction performance, and stability of surface area under accelerated high voltage cycling tests (CV cycling) in each of 64 regions.

In the following examples, we show how the measured Pt[111] crystallite grain sizes, Pt fcc lattice spacing, and measured electrochemical surface areas vary with the different binary, ternary and compound intermixed material sets identified above.

Pt Binaries: PtNb, PtBi, PtRe, PtCu, PtHf, PtZr and Pt(LiF)

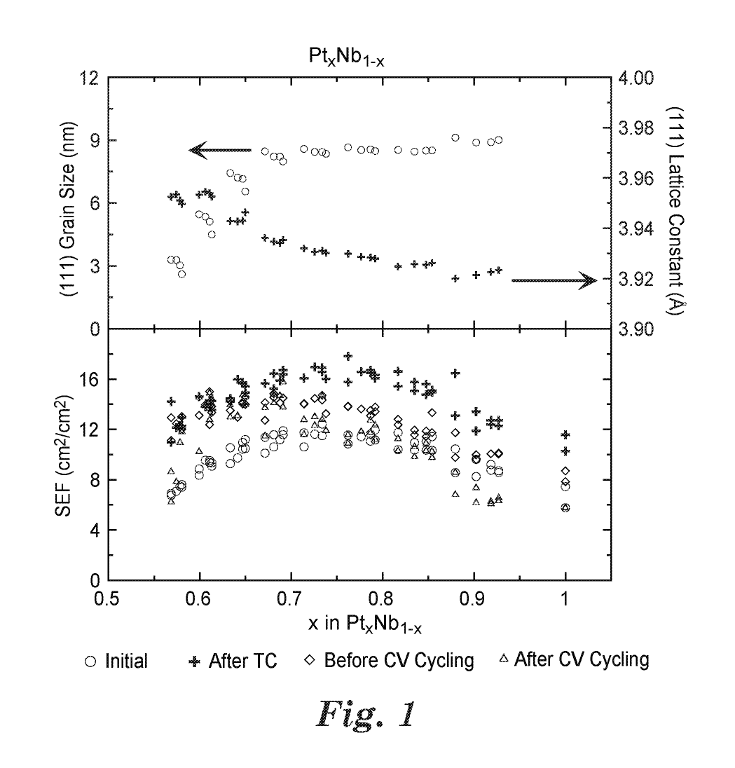

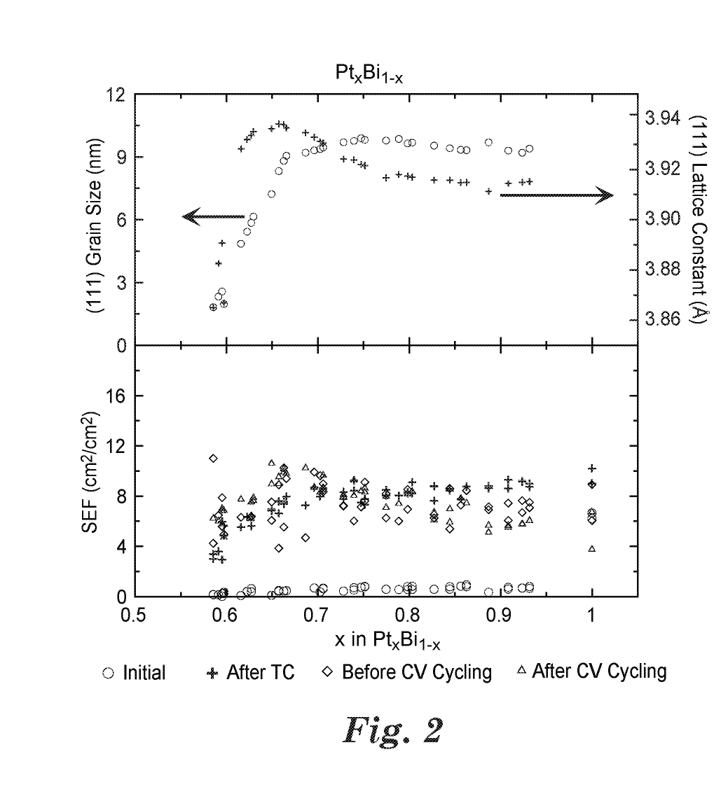

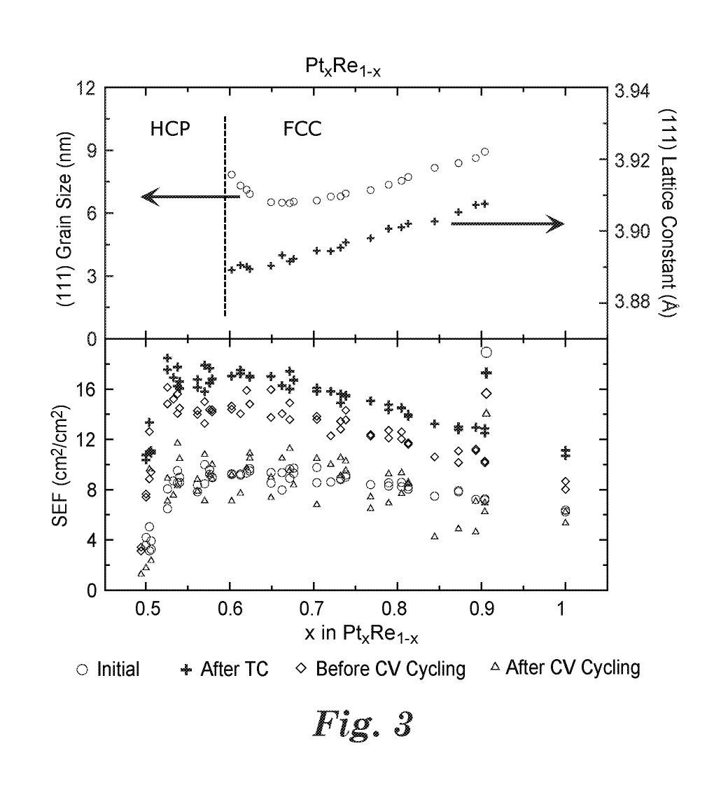

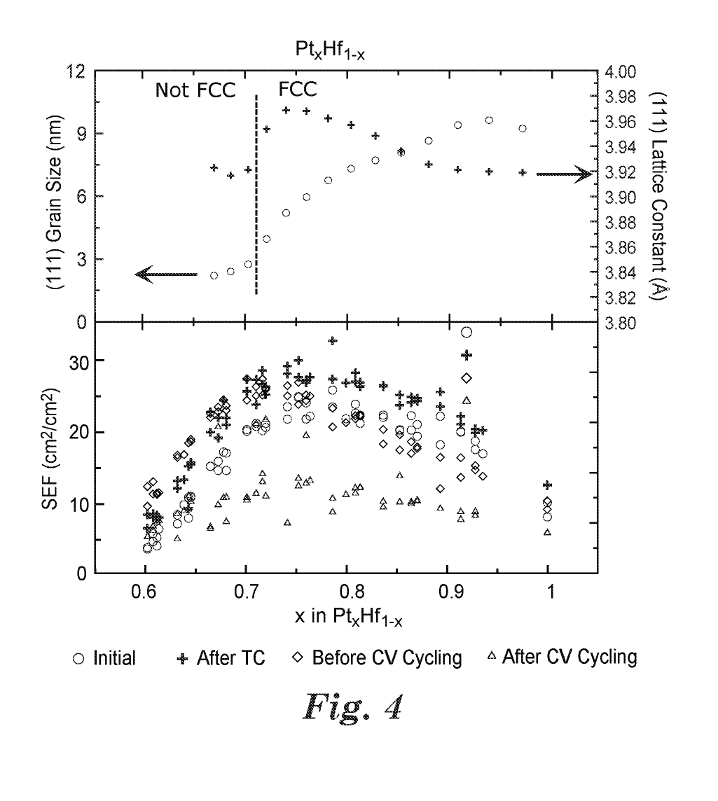

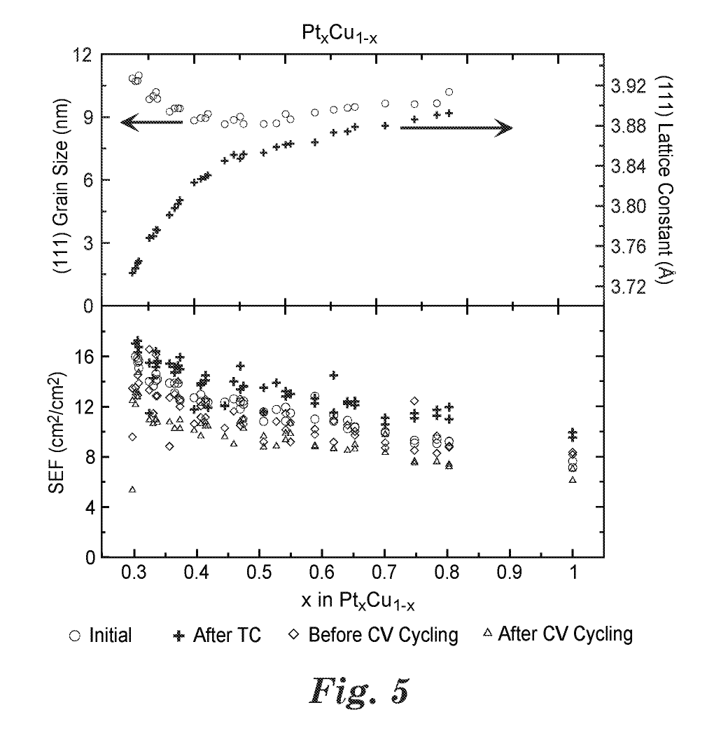

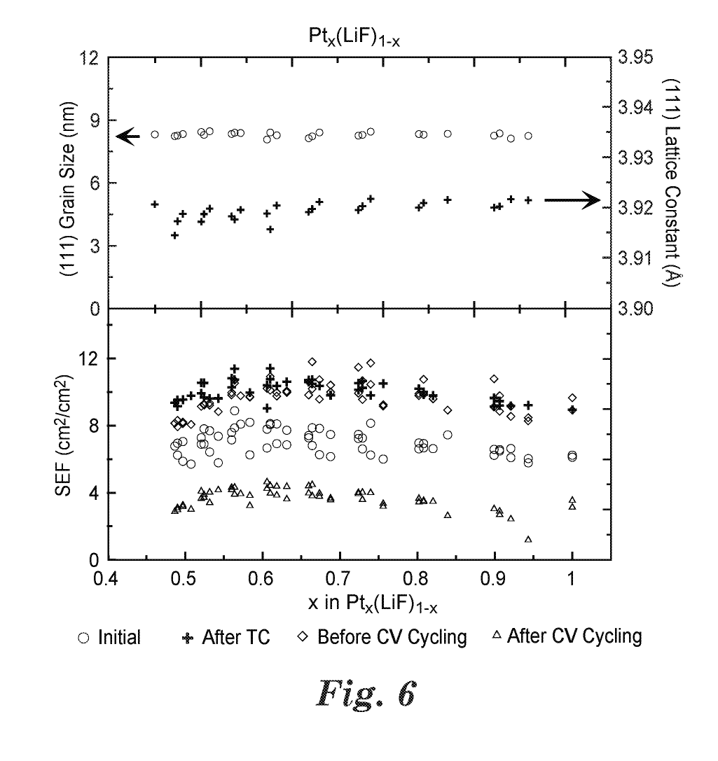

Results for these Examples are presented in FIGS. 1-6.

These examples show that depending on the type of metallic element added to the Pt, the grain size and lattice spacing can change in very different ways with the atomic fraction, (1-x) of the added element. The Pt grain size and lattice parameter can be nearly independent of (1-x) as in the case of PtₓLiF₁₋ₓ, remain nearly independent of (1-x) up to a certain value and then change dramatically, as in the case of PtₓNb₁₋ₓ, or vary more uniformly over a wide range of (1-x), as in PtₓBi₁₋ₓ and PtₓRe₁₋ₓ, or vary significantly over a very small range of (1-x), as in PtₓHf₁₋ₓ. Among the samples, grain size and lattice parameter can vary in different directions, up or down, as x increases. The surface area data, SEF (cm²/cm²), of most relevance are the plotted values identified as “After TC”, meaning after break-in conditioning of the MEA. The SEF values generally increase due to this beneficial conditioning, but generally decrease after the CV cycling which is a durability test intended to assess if the added element helped stabilize the Pt grains against dissolution under high voltage cycling.

Pt Ternaries: PtCoAu, PtCoZr, PtCoIr, PtTiC and PtTiB

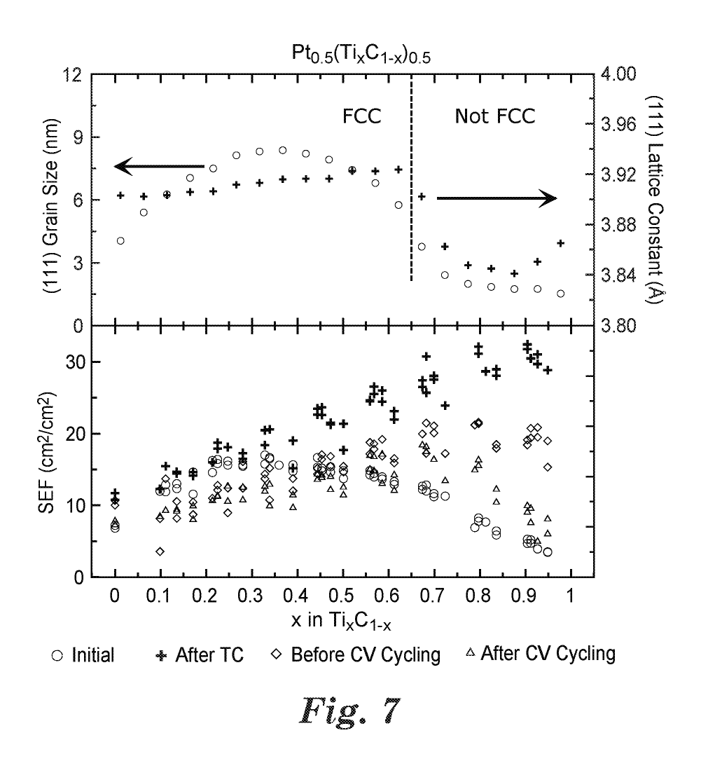

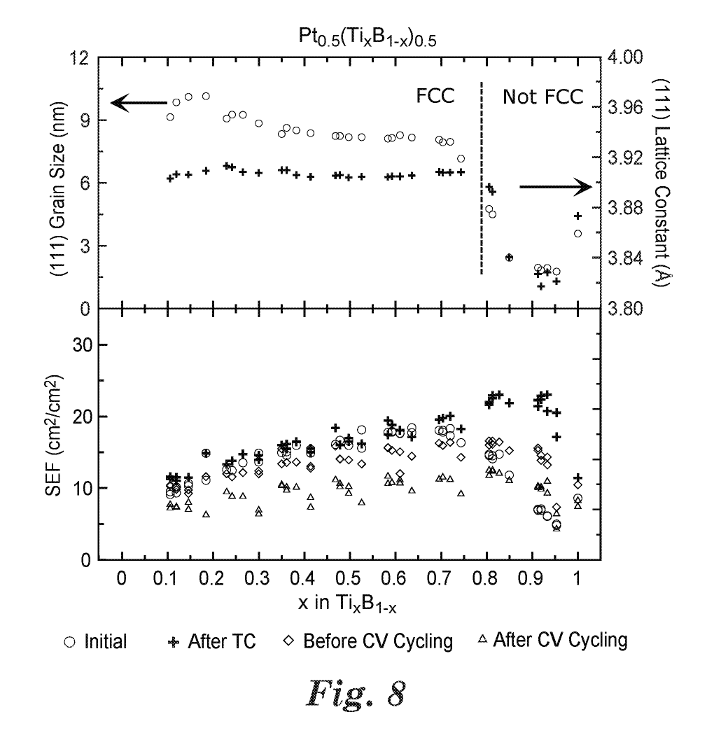

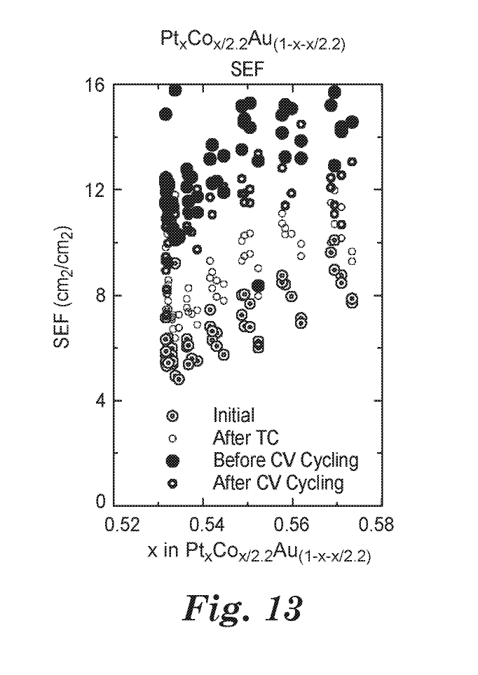

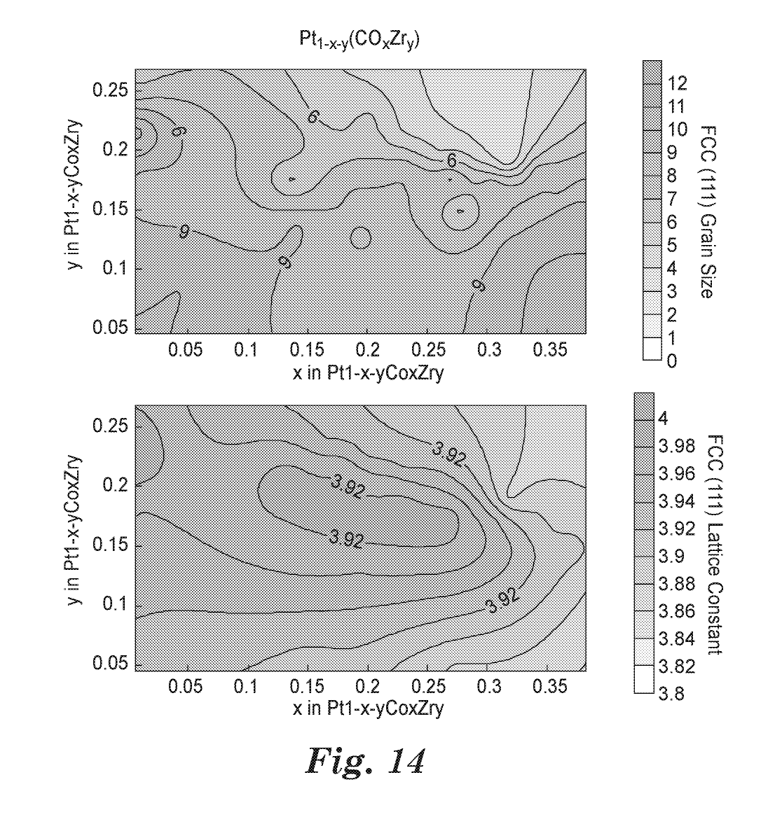

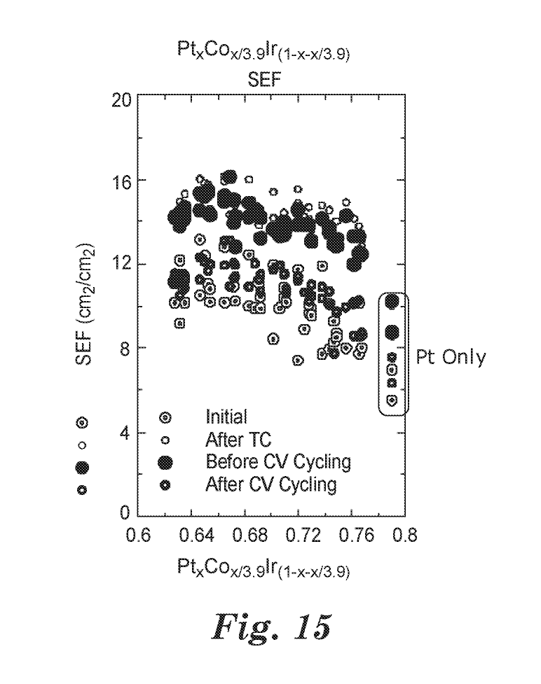

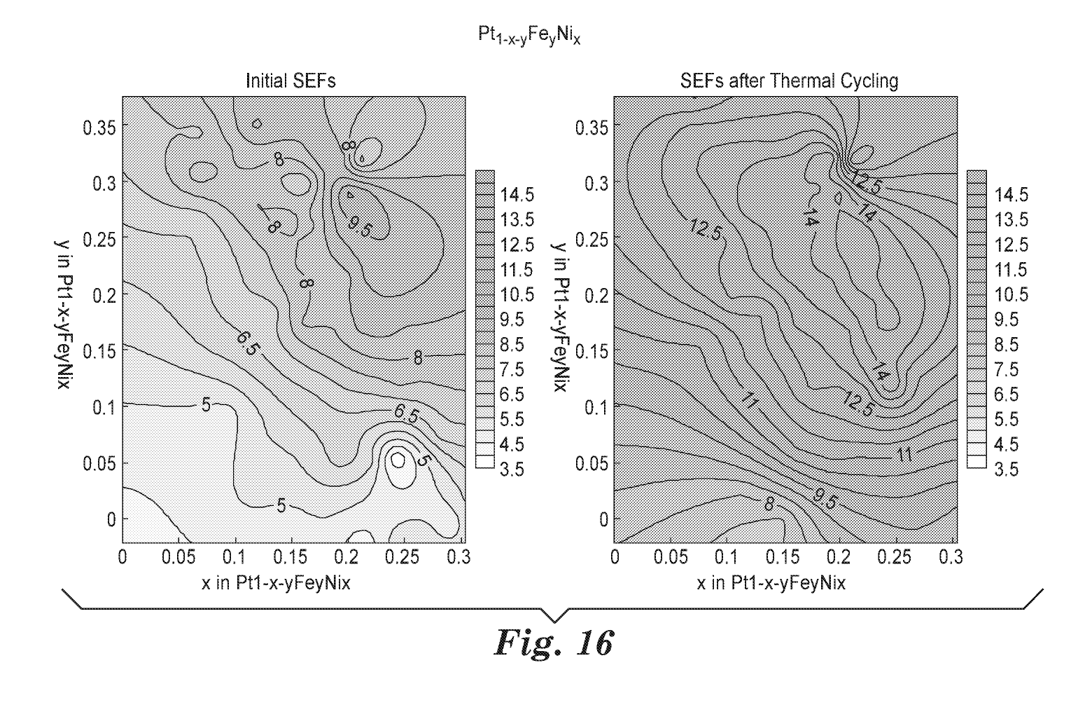

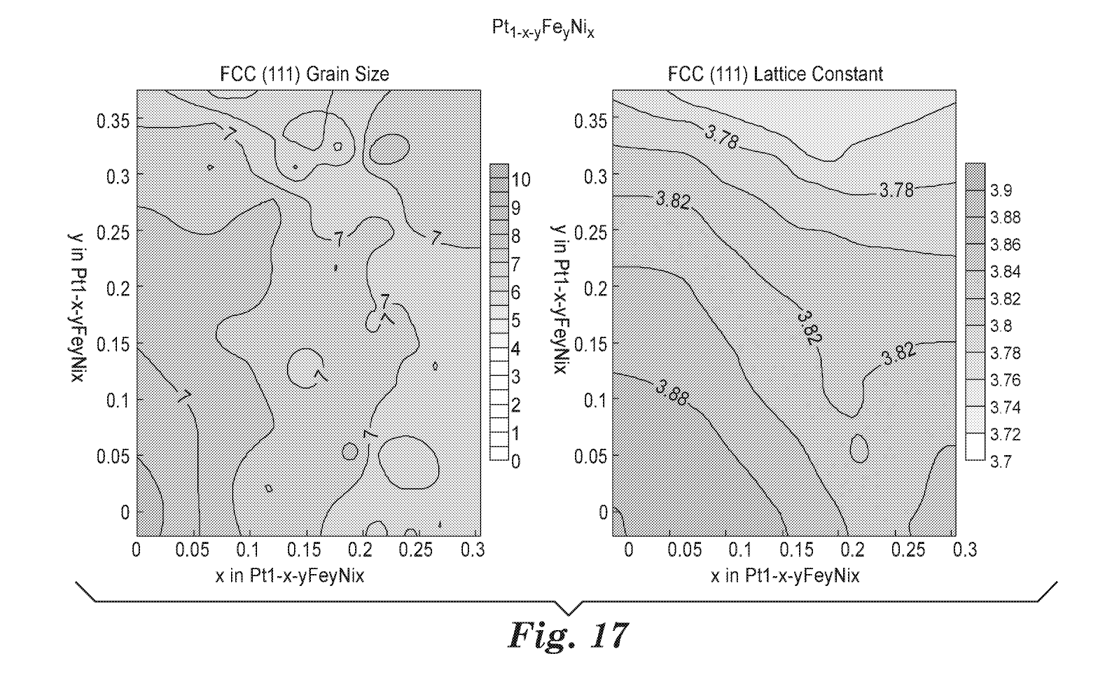

Results for these Examples are presented in FIGS. 7, 8 and 13-15.

Pt Compounds: Pt(SiO₂), Pt(ZrO₂), Pt(Al₂O₃), Pt(TiSi₂), Pt(TiO₂), Pt(Misch Metal) and Pt(CoMn)(SiO₂)

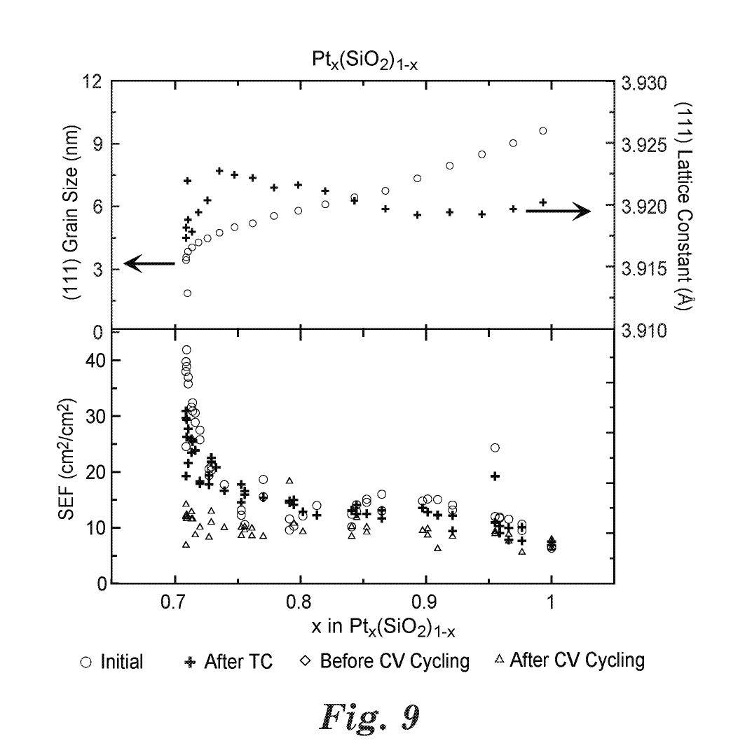

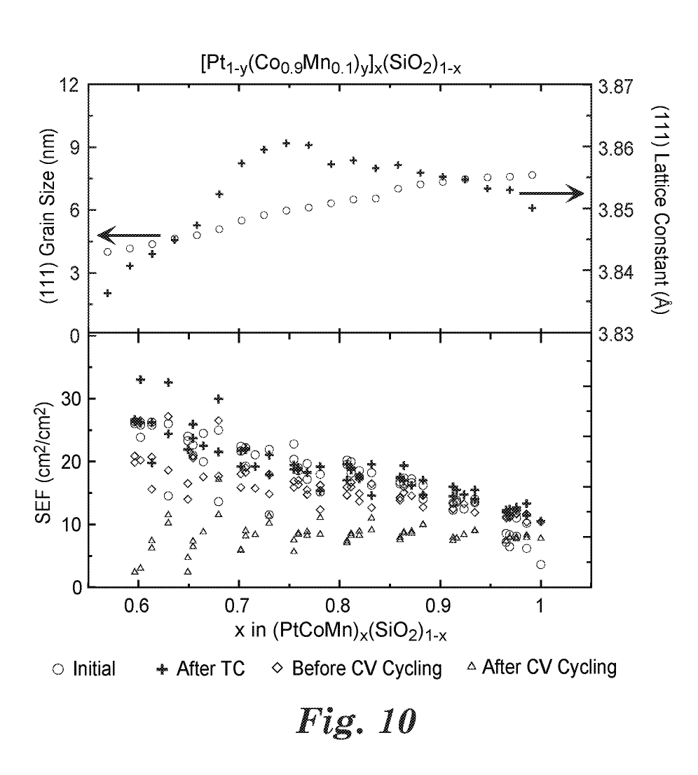

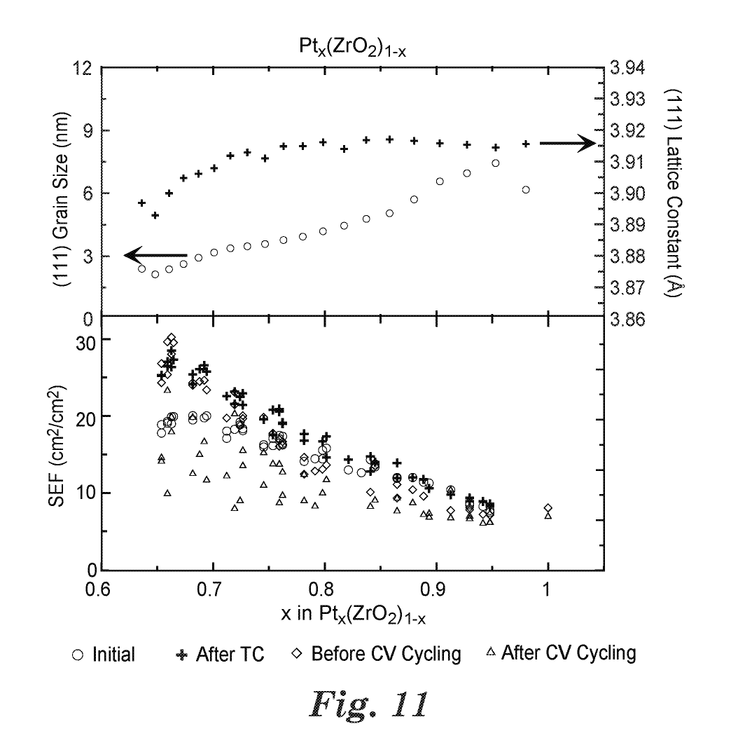

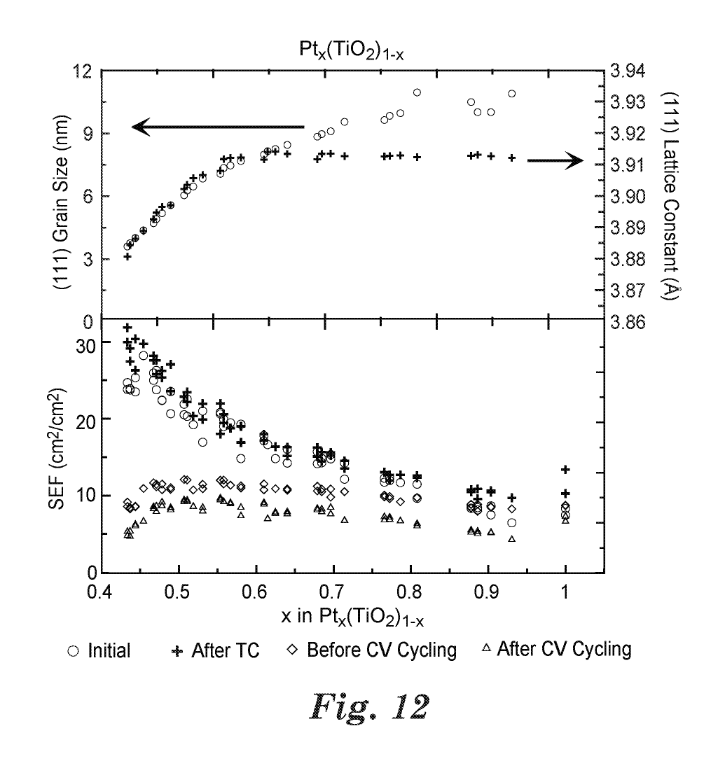

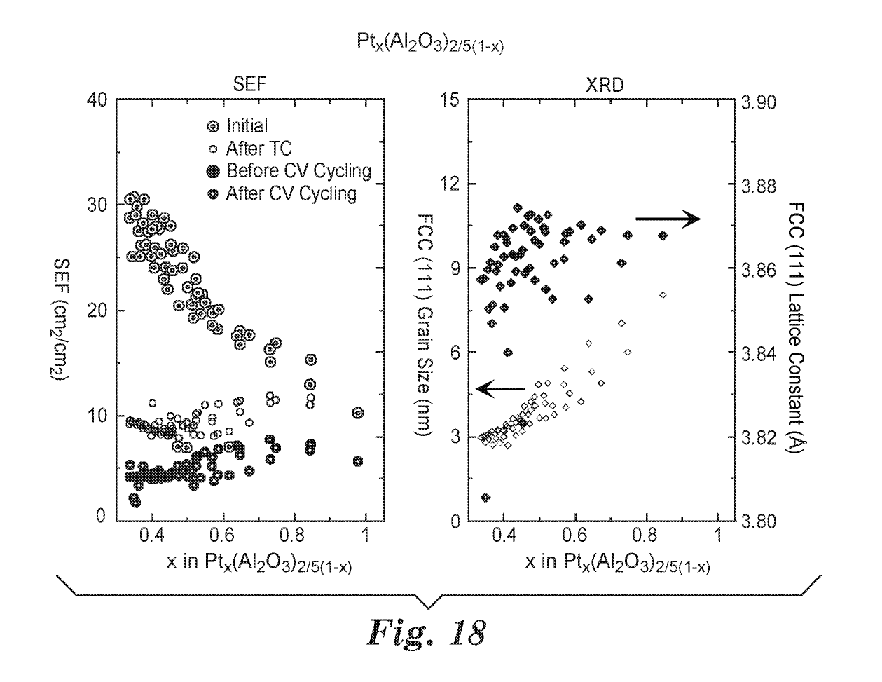

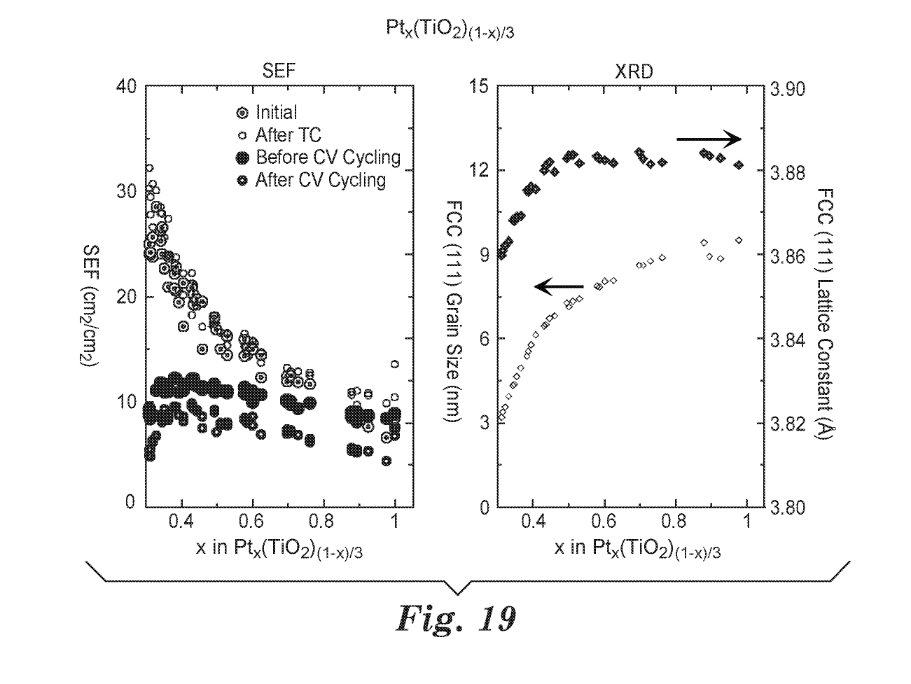

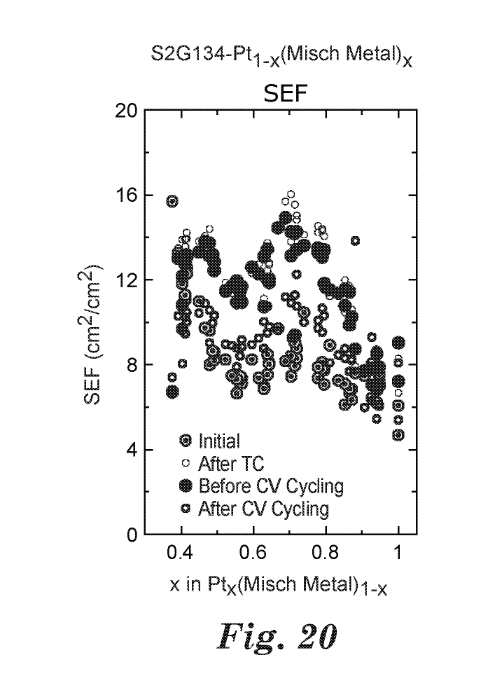

Results for these Examples are presented in FIGS. 9-12, 18-20.

In these examples it is seen that the grain size can be varied independently of the lattice constant, as in Ptₓ(SiO₂)₍₁₋ₓ₎, or they can vary similarly with x as in Ptₓ(ZrO₂)₍₁₋ₓ₎, and Ptₓ(TiO₂)_{(1-x)/3}. In the case of Ptₓ(TiSi₂)_{(1-x)/3}, the lattice constant and grain sizes are independent or only weakly dependent on x. In the case of Misch Metal, no Pt lattice forms and the structure is essentially amorphous.

In many of the cases, the initial surface area is extremely high for NSTF catalysts, 30-40 cm²/cm² versus the normal 10-12 for these Pt loadings, at Pt atomic fractions below 0.5. In general, grain size decreases as the Pt atomic fraction decreases, correlating with the increase in surface area.

Various modifications and alterations of this disclosure will become apparent to those skilled in the art without departing from the scope and principles of this disclosure, and it should be understood that this disclosure is not to be unduly limited to the illustrative embodiments set forth hereinabove.

We claim:

1. A fuel cell catalyst comprising nanostructured elements comprising microstructured support whiskers bearing a thin film of nanoscopic catalyst particles comprising a catalyst material according to the formula PtₐCo_{b}M_{c} where a+b+c=1, a is between 0.3 and 0.9, b is greater than 0.05, c is greater than 0.05, and M is selected from the group consisting of Au, Zr, and Ir.

2. The fuel cell catalyst according to claim 1 where the catalyst material is according to the formula PtₓCo_{(x/2.2)}Au_{(1-x-x/2.2)} where x is between 0.53 and 0.58.

3. The fuel cell catalyst according to claim 1 where the catalyst material is according to the formula Pt_{(1-x-y)}CoₓZr_{y} where x and y satisfy the conditions 2y+x>0.35, 4y+x <1.00 and x<0.7.

4. The fuel cell catalyst according to claim 1 where the catalyst material is according to the formula PtₓCo_{(x/3.9)}Ir_{(1-x-x/3.9)} where x is between 0.63 and 0.76.

5. The fuel cell catalyst according to claim 5 where x is between 0.65 and 0.69.
